(19) United States
(12) Patent Application Publication
(10) Pub. No.: US 2025/0199514 A1
(43) Pub. Date: Jun. 19, 2025

(54) IEC 61499-PART-COMPATIBLE COMPUTING APPARATUS AND OPERATING METHOD THEREFOR

(71) Applicant: Schneider Electric Industries SAS, Rueil-Malmaison (FR)

(72) Inventors: Marcus Würr, Erlenbach (DE); Sebastian Diehm, Hasloch (DE)

(73) Assignee: Schneider Electric Industries SAS, Rueil-Malmaison (FR)

(21) Appl. No.: 18/979,839

(22) Filed: Dec. 13, 2024

(30) Foreign Application Priority Data
Dec. 14, 2023 (EP) 23307207.3

(51) Int. Cl. G05B 19/4155

(52) U.S. Cl. CPC G05B 19/4155; G05B 2219/31229

(57) ABSTRACT

An IEC 61499-part-compatible computing apparatus has an arithmetic logic unit, a RAM, a ROM, an operating system memory, one or more interfaces for the input and/or output of data and signals and a bus connecting one or more or all of the above and/or the following components. A program memory is adapted to store a program that has one or more functional blocks, wherein a functional block has one or more programmed functions and can have a programmed execution control chart. An execution engine is adapted to create a first execution environment data set for configuring an execution environment for executing a functional block of a program. Said execution engine is also adapted to create a second execution environment data set while or before a functional block or a function is executed in an execution environment that is configured by a first execution environment data set previously created by the execution engine.

The invention relates to an IEC 61499-part-compatible computing apparatus and an operating method therefor.

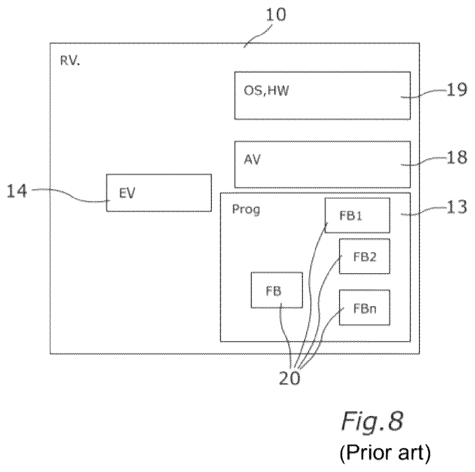

IEC 61499 is an international standard for the programming of process measurement systems and process control systems. FIG. 8 schematically shows the general structure of a known computing apparatus according to IEC 61499. The computing apparatus 10 has general hardware and an operating system 19 that serve to execute and control the general and program-specific sequences. The specific hardware is not shown further in FIG. 12, but comprises one or more CPUs and/or cores, RAM, ROM, in particular a program memory 13, registers, a bus, interfaces for incoming and outgoing communication with external components such as sensors, actuators, networks, and an event management apparatus 14.

Insofar as a program memory is addressed now and in the following, this can, on the one hand, be the non-volatile memory, which stores a program even in the switched-off state of the computing apparatus or beyond the computing apparatus or when said program is not executed, or it can be the usually volatile memory, which can be read quickly, of the program at the point in time of the execution of the program. 13 designates the program memory and the program stored therein.

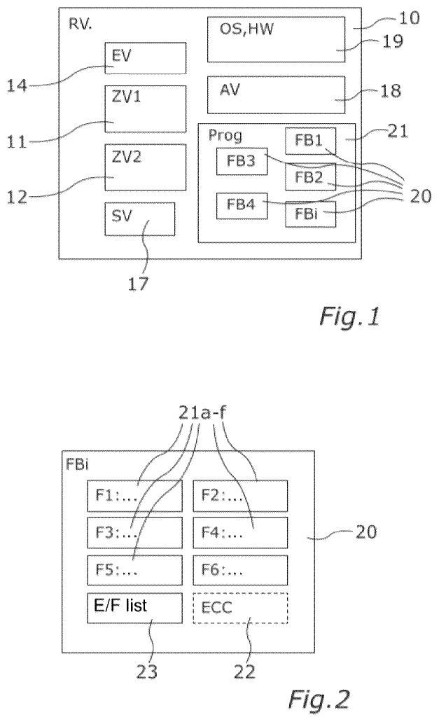

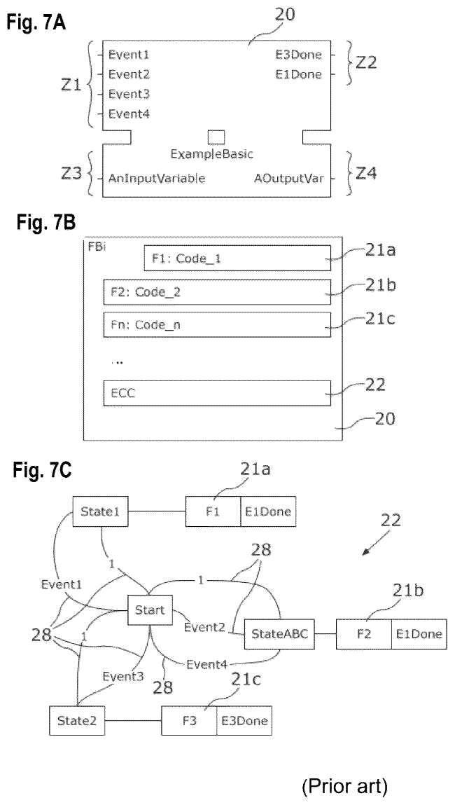

A program in the memory 13 consists of one or more functional blocks 20, symbolized by FB1, FB2 . . . FBi in FIG. 1. As schematically shown in FIG. 7B, a conventional functional block 20 consists of a plurality of programmed functions 21a to 21n and an execution control chart 22 that controls the interaction of the functions 21. The functions are sometimes also called methods.

In more recent versions of IEC 61499, the sequence of the various components of a program is event-controlled so that the computing apparatus 10 also contains an event management apparatus 14. The program 13, in particular the functional blocks 20 therein, and further in particular the functions 21 in the functional blocks 20, generate events that in turn call up functional blocks 20 or specific functions 21 therein. These events are recorded and appropriately processed by the event management apparatus 14. The event management apparatus 14 can be part of the operating system or it can be a specifically provided component. It can be software-implemented.

A computing apparatus 10 also has an execution engine 18 that is responsible for providing a functional block 20 to be executed or a function 21 to be executed with an execution environment in which and with which said functional block or function can be executed.

An execution environment is in this respect defined by a data set that makes selectable and settable specifications for the apparatus parameters or logistical parameters to be set for the execution of a functional block or a function. This can involve specifying memory areas, hardware components to be selected, priorities and the like.

In known IEC 61499-compatible computing apparatuses, the execution engine 18 is connected to an execution environment created by it such that said execution engine does not create a new execution environment data set and a corresponding new execution environment is not generated as long as an execution environment data set previously created by the execution engine is used for the execution of a functional block or a function. Only after the end of the use is it possible for a known execution engine 18 to provide a new execution environment by generating a new execution environment data set. In this respect, an execution engine 18 can assumed to be stateful. As long as an execution environment defined by said execution engine is in use, its state is “occupied”, and only otherwise is its state “free”, wherein other states are also possible.

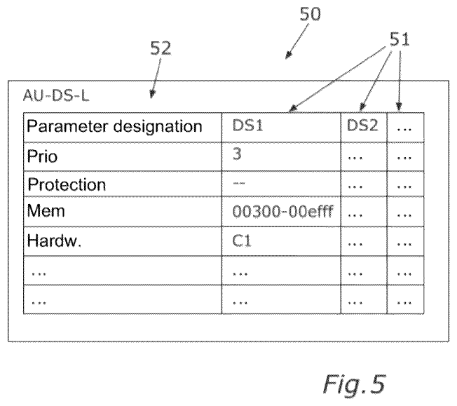

FIG. 5, which shows the features of the invention, schematically shows execution environment data sets DS 51 known on their own. Specific variables such as priority, protection mechanisms, memory area, hardware selection, etc. are assigned specific values, for instance 3, 2, 003000 to 00efff, etc. These values are then used to set up an executable execution environment in which a functional block 20 or a function 21 can be executed.

The assignment of a functional block to be executed or a function to be executed to an execution environment can in this respect be performed by the execution engine 18 itself, or the operating system 19 can do this.

The execution engine 18 can be part of the operating system or can be a stand-alone apparatus. It can be software-implemented.

FIG. 7B, already mentioned, shows the structure of a functional block 20 according to IEC 61499. It has the aforementioned various functions 21a to 21n that are also indicated by F1, F2, . . . , Fn in FIG. 7B. Behind each of these functions is a programming of a specific functionality, for instance a calculation process, a data input process or data output process or similar.

Furthermore, a functional block 20 contains an execution control chart 22 that controls the interlocking and sequencing of the various functions of the functional block and also other functional blocks, if applicable. As already mentioned, more modern versions of IEC 61499 are event-controlled. The execution control chart controls the “inner workings” of a functional block. It defines which functions are executed. It additionally defines the reaction of a functional block to incoming events. It can also define the triggering of outgoing events by the functional block.

Finally, the functions 21 in the functional blocks 20 are adapted to generate events that call up other functions 21 in the same functional block 20 or in another functional block 20. In the execution control chart 22, these links between events and the functions 21 called up by them and/or output events generated by them are visualized. In fact, programming of the execution control charts 22 of such functional blocks 20 can take place with a graphical user interface GUI that generates images as qualitatively shown in FIG. 7C and corresponding machine-usable execution control charts 22.

A property of known execution control charts 22 is that they can only be used again when no function 21 called up by them is still being processed. In other words, a known execution control chart 22 can be thought of as stateful such that it is “occupied” when a function 21 called up by it is in progress, and that it is only otherwise “free”.

FIG. 7A shows the schematic representation of a functional block 20 in its links to the external. The functional block 20 has input events 71, which means that it contains functions 21 that are to be executed in response to the input events 71. A functional block 20 also has output events 72. These are events that are generated by functions 21 of the functional block 20 and that can in turn call up functions 21 in other functional blocks. It should be noted here that functions 21 in a functional block 20 can also call up other functions 21 internally in their own functional block 20 that therefore do not have to be visible in the external integration of a functional block 20.

A functional block 20 also receives certain input data 73 or has input options or read options for this purpose. It can equally generate output data 74 and has output options and write options for this purpose. In a coarsened view, the execution control charts 22 can be thought of as sitting between input events 23 and output events 24 and the programmed functions 21 can be thought of as sitting between input data 25 and output data 26.

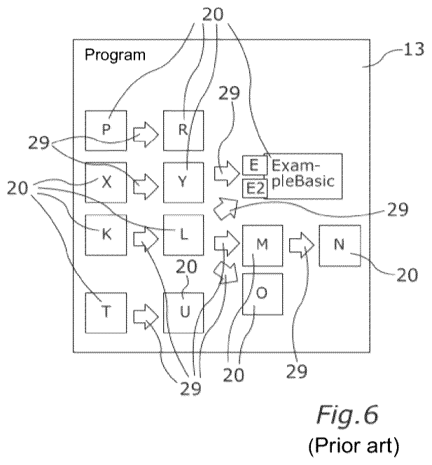

FIG. 6 shows the structure of a program 13 according to IEC 61499. The program 13 can have a series of functional blocks 20 that are marked in FIG. 10 with capital letters from K or with “example basic” to distinguish them. Event-controlled transitions 29 take place between them. In contrast, the arrows 28 in FIG. 7C characterize event-controlled transitions inside a functional block 20. FIG. 10 shows that a functional block 20, for example “example basic”, can be called up by a plurality of other functional blocks 20, such as Y and L. A single functional block 20, in particular functions 21 therein, such as L in FIG. 10, can also generate a plurality of different events that each call up different functional blocks 20, in FIG. 10 “example basic” or M or O, or functions 21 therein.

In modern execution engines, multitasking is possible such that a plurality of programs or a plurality of specific functional blocks 20 or even more specific functions 21 can be executed simultaneously or virtually simultaneously. They can really be simultaneously executable if a plurality of arithmetic logic units (ALUs), cores or CPUs are present. They can be virtually simultaneously executable if the processing power of specific hardware in a time multiplex is alternately assigned to a plurality of programs or functional blocks or functions.

The event-controlled processing of a program 13, on the one hand, and the possibility of multitasking, on the other hand, leads to numerous possible constellations of access to functional blocks 20 or functions 21. On the one hand, this can lead to unwanted double executions and access conflicts or memory conflicts. In contrast, the above-described known statefulness of the execution engine 18, on the one hand, and the execution control apparatus 22, on the other hand, provides protection by noticeably limiting the multiple execution of functional blocks and functions.

On the other hand, this had the result that the computing power of modern systems cannot be utilized since blockages occurred even when work could actually take place. An example of this is a data input that is expected in a function, but does not occur. Nothing happens during the waiting time. However, a conventional execution control chart 22 and a conventional execution engine 18 are blocked in their statefulness and do not allow the system to be used otherwise during such waiting times, for example.

EP 4012517 A1 and EP 4012516 A1 disclose execution environments for a programmable logic controller that can be controlled in an event-oriented manner.

EP 2899633 A1 describes an event-oriented programming method for a programmable logic controller.

EP 3026556 A1 describes the event management for an industrial control.

The object of the invention is to provide an IEC 61499-part-compatible execution engine and an operating method therefor that enable the efficient use of system resources.

This object is satisfied by the features of the independent claims.

An IEC 61499-part-compatible computing apparatus has an arithmetic logic unit, a RAM, a ROM, an operating system memory, one or more interfaces for the input and/or output of data and signals and a bus connecting one or more or all of the above and/or the following components. It has a program memory that is adapted to store a program that has one or more functional blocks, wherein a functional block has one or more programmed functions and can have a programmed execution control chart. It has an execution engine that is adapted to create a first execution environment data set for configuring an execution environment-sometimes called a task-for executing a functional block of a program or a function of a functional block.

The execution engine is adapted to create a second execution environment data set while or before a functional block or a function is executed in an execution environment that is configured by a first execution environment data set previously created by the execution engine.

The execution engine can be adapted to set up a corresponding second execution environment as executable in accordance with the data of the second execution environment data and, if necessary, to cooperate with the operating system accordingly. In this respect, the definition of the data of the second data set and the executable setup of the second execution environment can be a uniform and, where possible, hardly distinguishable process. This process can take place while or before a functional block or a function is executed in a first execution environment that is configured by a first execution environment data set previously created by the execution engine.

The data of an execution environment data set can, but do not have to, be explicitly saved after the executable setup of a corresponding execution environment.

Where the computing apparatus is referred to here as partly compatible with IEC 61499, this can mean that it uses a plurality of features or components of IEC 61499 and possibly, but not necessarily, all of its components. It can mean that the computing apparatus does not use one or more explicitly or implicitly determined features of IEC 61499 or has them in modified form. It can mean that the computing apparatus is compatible with IEC 61499, unless otherwise explicitly or implicitly described in this text or required for this purpose.

The execution engine can also be adapted such that it creates a second execution environment data set before the latter is actually required for the execution of a functional block or a function. Said second execution environment data set can so-to-say be created “for stock” and is then available when it is needed. The creation “for stock” has the advantage that the time-consuming process can be completed as early as possible. The disadvantage is that this involves memory consumption.

The execution engine can also be adapted such that it only creates a second execution environment data set “on demand”, i.e. when an execution environment is required for the execution of a further functional block or a further function. The creation “on demand” has the disadvantage that the time-consuming process is carried out late and possibly has a blocking effect. The advantage is that no memory consumption is given beforehand.

The execution engine can be adapted as configurable as to whether it creates one or more execution environment data sets for stock, as just described, or only on demand, as just described. The configuration can be carried out by a user.

Generally speaking, the execution engine is therefore enabled not to be blocked during or by the execution of a functional block or a function in a previously created execution environment for the creation of further execution environment data sets. Said creation can also comprise a software-implemented execution engine being adapted for the execution in multiple instances that can operate independently of one another a priori, in particular can create execution environment data sets independently of one another.

In the computing apparatus, the execution engine can have an operation-dependent state. A first state control apparatus then serves to directly or indirectly control the state of the execution engine such that said execution engine creates or can create a second execution environment data set after the creation of a first execution environment data set but before the use or before the termination of the use of said first execution environment data set. Said creation can, as already mentioned, take place for stock and/or on demand.

The computing apparatus can have a first state control apparatus for controlling the state of the execution engine, wherein the state comprises at least the two values “occupied” or “free” and is switched between at least these values by the first state control apparatus, preferably in that a corresponding first marker is written to accordingly by the first state control apparatus. In particular, the first state control apparatus is adapted to switch the state of the execution engine from “occupied” to “free” immediately after the execution engine has created a first execution environment data set or while a functional block is executed in an execution environment that is configured by a first execution environment data set previously created by the execution engine.

The switchover described can also mean that the state of an execution engine is explicitly indicated with a marker and the latter is queried. In this respect, the state control can mean that the state marker itself is set appropriately, in particular to “free” as soon as this is possible, as described above. The state control can also mean that the query result of such a marker is influenced as desired, in particular such that a possibly existing “occupied” specification is ignored or is nevertheless evaluated as “free”.

The execution engine and/or the first state control apparatus can be software-implemented and/or can be a part of the operating system or a component that is independent thereof. In a software-implemented manner, the software of the execution engine and/or of the first state control apparatus can be delivered with the program to be executed.

The execution engine can be adapted to define one or more of the following parameters for an execution environment data set:
one or more memory areas,
a priority specification relating to a functional block to be executed in the execution environment,
an arithmetic logic unit to be used for the execution of the functional block or an arithmetic logic unit type,
an identification of the execution environment data set.

An execution environment data set therefore contains various configuration specifications that are used when executing a functional block or a function in order to configure the computing apparatus and the sequences therein for the execution as desired. An execution environment data set can be read before a function or a functional block is executed. The specifications and values read in this respect can then be set and can thus be used for the execution of a functional block or a function.

The execution engine can be adapted to set up one or more execution environment data sets such that they can be called up by the operating system and used for the execution of a functional block, in particular to store said one or more execution environment data sets, for example as a table, and/or can be adapted to set up one or more execution environments as executable or usable in accordance with the data sets.

The execution engine can further be adapted to set up an execution environment data set such that it can be called up by the operating system and evaluated for the execution of a functional block, in particular to store said execution environment data set.

The assignment of a function to be executed or a functional block to be executed to an execution environment can be performed by the operating system. The operating system can also perform the setting of the computing apparatus in accordance with the values in the execution environment data set. However, it is also possible to have these measures carried out by separate components beyond the operating system. These separate components can be software-implemented and can be provided independently of the operating system.

In an operating method in an IEC 61499-part-compatible computing apparatus, an execution engine creates a second execution environment data set while a functional block is executed in an execution environment that is configured by a first execution environment data set previously created by the execution engine.

In such an operating method, the execution engine is therefore not blocked for the duration of the execution of a currently running functional block or a running function, but can continue to work, in particular precisely to create a further execution environment data set.

An IEC 61499-part-compatible computing apparatus can be adapted as above. It can be equipped with an arithmetic logic unit, a RAM, a ROM, an operating system memory, one or more interfaces for the input and/or output of data and signals and a bus connecting one or more or all of the above and/or the following components and with a program memory that is adapted to store a program during its execution, wherein the program has one or more functional blocks, wherein a functional block has one or more programmed, individually executable functions that can generate events.

A memory, in particular the program memory, is adapted to store, with and for a functional block, an event-function assignment list, belonging to the programming of the functional block, of one or more event-function assignments that each assign, to a specific event occurring in the computing apparatus, one or more functions of a functional block, said function(s) to be executed in the computing apparatus in response to this event. The computing apparatus, in particular an event control apparatus thereof, is adapted, in response to a specific event, to bring a specific functional block and/or a specific function therein to execution in accordance with an entry in the event-function assignment.

With this aspect of the invention, it is possible to use said stateless event-function assignment instead of the stateful execution control chart of a functional block so that in particular incoming events can be processed even if another function is currently being processed.

The event named in an event-function assignment can be an event occurring in the functional block that contains the event-function assignments or an event occurring in another functional block. The function named in an event-function assignment can be a function programmed in the functional block that contains the event-function assignments or a function programmed in another functional block.

An event-function assignment list can be created in the form of a list or a table with one column each for events and for assigned functions. The event of an event-function assignment can have am event identification unique in the program 13 and optionally also a priority specification for the event and optionally also an identification, unique in the program, of the functional block that contains the event-function assignment with the event. The function of an event-function assignment can have a function identification unique in the program and optionally also a priority specification for the function and optionally also an identification, unique in the program, of the functional block that contains the function.

The event control apparatus can be software-implemented and can be part of the operating system. The event control apparatus can be adapted to register an event generated by an executed function and, in dependence thereon and on possibly further operating parameters, to bring a function of a functional block to execution.

The program memory can be adapted to also store a programmed execution control chart for a functional block in addition to the event-function assignment list, wherein the computing apparatus is then adapted to process the functional block or functions thereof in accordance with the execution control chart.

It is thus conceivable to use a conventional execution control chart in addition to the described event-function assignment. For example, specific events can be stored in the conventional execution control chart, while other events can be captured in the event-function assignment described.

A program memory has a program for a computing apparatus partly compatible with IEC 61499, said program having one or more functional blocks, wherein a functional block has one or more programmed, individually executable functions that can generate events. The program memory has at least one memory area that stores, for a functional block, a programmed event-function assignment list of one or more event-function assignments that each assign, to a specific event generated in the stored program, a function a functional block, said function to be executed in the computing apparatus in response to this event.

The program memory can have, for the event of an event-function assignment, an event identification unique in the program and optionally also a priority specification for the event and optionally also an identification, unique in the program, of the functional block that contains the event-function assignment with the event, and/or the program memory can have, for the function of an event-function assignment, a function identification unique in the program and optionally also a priority specification for the function and optionally also an identification, unique in the program, of the functional block that contains the function.

An operating method in an IEC 61499-part-compatible computing apparatus can be designed as already mentioned above. The calling up of functions of a functional block takes place in response to events in accordance with a programmed event-function assignment list of one or more assignments between events and functions to be executed in response thereto.

A conventional stateful execution control chart is therefore not necessarily used here. Instead, the event-function assignment is managed stateless and is available at any time in response to an occurring event.

An IEC 61499-part-compatible computing apparatus, which can be adapted as described above, has an arithmetic logic unit, a RAM, a ROM, an operating system memory, one or more interfaces for the input and/or output of data and signals and a bus connecting one or more or all of the above and/or the following components.

It has a program memory that is adapted to store a program that has one or more functional blocks, wherein a functional block has one or more programmed functions and a programmed execution control chart.

Said IEC 61499-part-compatible computing apparatus has a second state control apparatus for controlling the state of an execution control chart-ECC-of an executed functional block of a program. The state has at least the two values “occupied” or “free” and is switched between at least these values by the second state control apparatus, preferably in that a corresponding second marker is written to accordingly by the second state control apparatus. The second state control apparatus is adapted to switch the state of an execution control chart from “occupied” to “free” while or before a function previously called up by the execution control chart is executed.

The second state control apparatus can be software-implemented and can be part of the operating system or part of the programming of a functional block.

An operating method in an IEC 61499-part-compatible computing apparatus can be designed as described above. A state control of an execution control chart between at least the values “occupied” to “free” takes place such that the state of an execution control chart is switched from “occupied” to “free” while or before a function called up by the execution control chart is executed.

With this aspect of the invention, the statefulness of the execution control chart is modified such that a blocking of the execution control chart by a running function is avoided as far as possible by quickly rewriting its state from a blocked state to a usable state earlier than before. Thus, it becomes possible, for example, to trigger the execution of other functions in the case of a “pending” function, for instance a function waiting for an input, since the state of the execution control chart has been rewritten to “free” again early on.

In a computing apparatus as described above, the operating system or another component, preferably a software-implemented component, can be adapted to bring a functional block to be executed or a function to be executed to execution in an execution environment that is configured with an execution environment data set created by the execution engine.

A computing apparatus as described above can comprise an event management apparatus that can be software-implemented and/or can be part of the operating system and that is adapted to record events generated by functions, wherein such events can comprise the specification of a function to be executed and/or of a functional block to be executed and can comprise a priority specification for the function to be executed and/or the functional block to be executed.

The event management apparatus can be adapted to assign the function specified in the recorded event or the specified functional block to the execution of an execution environment that is configured with an execution environment data set created by the execution engine, or to enter the specified function or the specified functional block in a queue if no execution environment is available.

The event management apparatus can be adapted to collect event-function assignments from one or more event-function assignments of one or more functional blocks, for example during a program start, and to perform the assignment of a function or a functional block to an execution environment in accordance with the collected lists.

The initially described known embodiments of the execution engine and the execution control chart in a certain manner formed protection against unwanted double executions of functional blocks or functions therein or against data access conflicts or data storage conflicts by largely avoiding double executions. However, such protection mechanisms are not always necessary since there are programs that, due to their creation or due to the structure of the reality controlled by them, are insensitive to the problems mentioned. The above modifications represent an improvement for such programs since unnecessary waiting times are avoided, thus increasing throughput and execution efficiency.

However, programs can also be executable that need to be protected against unwanted double executions or read or write conflicts. A plurality of protection apparatus can be provided for this purpose.

A computing apparatus as described above can have a settable protection apparatus for blocking the execution of a function or a functional block and/or for protecting a sequence, in particular of a function call or a function or a functional block, against interruption. Said settable protection apparatus can be adapted to take protection settings from the programming of a functional block or of a function and to operate accordingly and/or to operate in accordance with specifications from an executed function or an executed functional block.

During operation, a protection apparatus can be implemented by the cooperation of a suitably operating protection device with setting specifications provided for this purpose. The protection device can be software-implemented and can be part of the operating system or it can be a stand-alone program or it can be delivered with the program to be executed or be part thereof. The setting specifications can be taken from the program to be executed or can result from other system settings or system states. Together, the protection device and the setting specifications ensure the setting, observation and resetting of a protection.

A computing apparatus can have, as a protection apparatus, a first protection apparatus for protecting a function or a functional block against double execution. The protection apparatus can have a mutex or a semaphore that is set on a first execution of the function to be protected or of the functional block to be protected and that is reset on the termination of said function or functional block. The program can have setting specifications set for this purpose.

A computing apparatus can have, as a protection apparatus, a second protection apparatus for blocking the execution of a function or a functional block, wherein the second protection apparatus can have a second mutex or a second semaphore that is set on an execution of another function or another functional block and that is reset on the termination of said function or functional block.

A computing apparatus can have, as a protection apparatus, a third protection apparatus for protecting a function call against interruption, wherein the third protection apparatus can have a third mutex or a third semaphore that is set on an execution of another function or another functional block and that is reset on the termination of said function or functional block.

The appropriate setting and resetting of protection mechanisms can then be part of the programming and part of the programming work of a programmer. Accordingly, a program can contain co-programmed instructions relating to the protection apparatuses, in particular specifications regarding when a protection is to be set and when it can be canceled again. A program memory then has corresponding memory areas comprising this protection programming or these protection instructions. A computing apparatus can have such a program memory. The program memory can be the program memory written to in a volatile manner during the program execution or a memory written to in a non-volatile manner that keeps the program when it is not being executed, possibly even beyond the execution engine.

A computing apparatus as described above can be adapted for the simultaneous or virtually simultaneous execution of a plurality of programs. For this purpose, said computing apparatus can use a plurality of physically different arithmetic units or cores or CPUs or ALUs or execution environments that are provided next to one another and that partly use shared further resources such as memories, registers, interfaces and execution environments. Or said computing apparatus can for this purpose use a single arithmetic unit or core or CPU or ALU or execution environment that represents a plurality of logical arithmetic units or cores or CPUs or ALUs or execution environments in timesharing or a time multiplex and then also partly uses the same further resources such as memories, registers, interfaces and execution environments. The protection apparatuses described then prevent access conflicts or data conflicts.

Embodiments of the invention will be described in the following with reference to the drawings; there are shown:

FIG. 1 a computing apparatus 10 comprising features of the invention;

FIG. 2 a functional block comprising features of the invention;

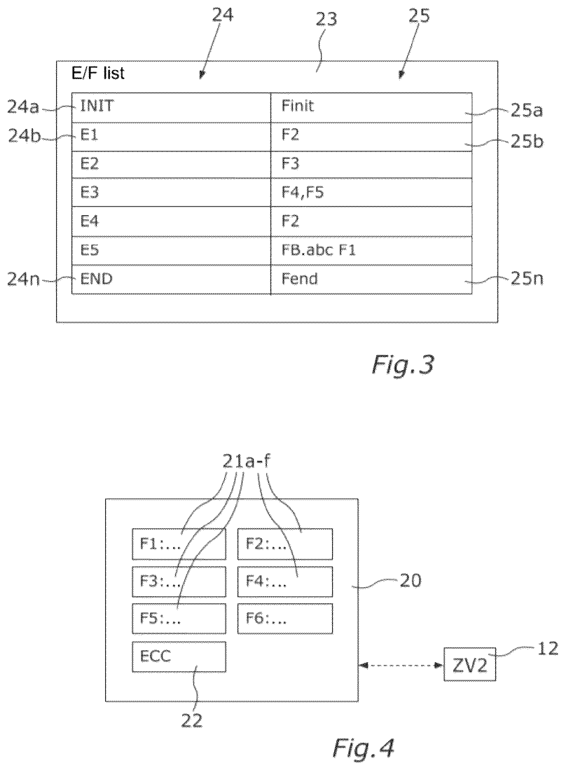

FIG. 3 an event-function assignment;

FIG. 4 a functional block comprising features of the invention;

FIG. 5 a table with execution environment data sets;

FIG. 6 the known structure of a program;

FIGS. 7A to 7C features of a functional block in the prior art; and

FIG. 8 a known computing apparatus.

FIG. 1 shows a computing apparatus 10 that is partly compatible with IEC 61499. It has generally required components 19 that include the operating system and hardware components such as memory, arithmetic logic unit, communication interfaces, bus, registers, volatile and non-volatile memory areas, energy supply and the like. 13 symbolizes a program or the memory area that is occupied by the program and that, on the one hand, can be the non-volatile memory for the program storage and data storage in the switched-off state of the apparatus, but can also be the memory written to in a volatile manner during the program execution.

The program 13 can be compatible or, as described above, partly compatible with IEC 61499. It has functional blocks 20 that can be compatible or partly compatible with IEC 61499.

As already mentioned, newer versions of IEC 61499 have an event-controlled sequence control. An event management apparatus 14 is provided for this purpose that takes the respective necessary measures. The event management apparatus 14 is drawn separately in FIG. 1. However, it can be part of the operating system. It can be software-implementable.

An execution engine 18 is also provided that is intended and adapted to define an execution environment for a functional block to be executed or a function to be executed. It does this by generating a suitable execution environment data set that can be used to configure the execution environment during the execution of the program, the function or the functional block. As stated above, in one embodiment of the invention, the execution engine 18 is designed such that it generates a second execution environment data set while or even before a functional block is executed in an execution environment that is configured by a first execution environment data set previously created by the execution engine. This can be achieved by a first state control apparatus 11 that enables the execution engine 18 to perform precisely the described creation of a second execution environment data set as described.

The execution engine 18 can be adapted to set up a corresponding second execution environment as usable or executable in accordance with the data of the second execution environment data set and preferably virtually simultaneously with the determination or definition of said data.

For this purpose, a cooperation with the operating system may be necessary to make the settings required for the operation at operating system level. The execution engine 18 can therefore be adapted to cooperate and/or communicate with the operating system, if necessary, in order to set up a corresponding second execution environment as executable in accordance with the data of the second execution environment data set.

The definition of the data of the second execution environment data set and the executable setup of the second execution environment can in this respect be a uniform, hardly distinguishable process. This process can take place while or before a functional block or a function is executed in a first execution environment that is configured by a first execution environment data set previously created by the execution engine.

Depending on the situation, a second execution environment set up in this way can then be immediately used for the execution of a further function or a further functional block due to be processed. Or said second execution environment exists set up, but—at least temporarily—in idle mode.

The first state control apparatus 11 can influence known blocking mechanisms for the execution engine 18 for the described creation of a second execution environment data set and/or for the executable setup of a corresponding second execution environment in order to remove corresponding blockings and/or can ensure that a software-implemented execution engine 18 can be executed multiple times. Insofar as an explicit marker is provided for a state of an execution engine 18, the first state control apparatus 11 can describe the marker appropriately, in particular such that the marker indicates a free or usable state of the execution engine 18 at an early stage. This can happen, for example, as soon as the creation and storing or making available of a first execution environment data set has been completed. In this way, it is also possible for the execution engine 18 to create execution environment data sets before they are actually required.

FIG. 5 shows a list 50 of a plurality of execution environment data sets DS1, DS2, . . . as they can have been created and stored in a table-like manner and/or as they can have been used for the setting of a plurality of execution environments, with or without having been explicitly stored. The data columns 51 contain value entries for the respective parameters of the execution environments. FIG. 5 shows a column 52 that specifies the parameters. It does not have to be present in real implementations. The list 50 of execution environment data sets 51 can be digitally maintained in the computing apparatus and kept available in a readable and usable manner for the operating system and/or existing execution environments were set up accordingly. Execution environment data sets 51 are shown that have specifications regarding parameters such as priority, protection mechanism, memory area, hardware allocation and the like.

The execution engine 18 can write to at least one column 51 of a memory area or a table 50 as depicted in FIG. 5 at an early stage, in particular when another execution environment data set is still in use or before any of these data sets are used. In this way, a blocking of the computing apparatus by non-existent execution environments or configuration instructions therefor in the form of the described data sets 51 is avoided.

FIG. 2 shows an embodiment, which can optionally be combined with the above features, of a functional block 20 that can be part of a program 13. Said functional block has a plurality of functions 21a to 21f, each of which is programmed individually and performs the desired work. The functions can be called up individually in accordance with events. Functions can also generate events that call up other functions. The functions called up by an event can be in the same functional block or in another functional block.

In addition, the functional block 20 has an event-function assignment list 23 that can be created in the form of a list or a table. FIG. 3 shows an example of such an event-function assignment list 23. It has at least one column 24 for different events and one column 25 for optionally different function specifications. The listed events can contain standard events such as initialization and termination (“INIT”, “END”) and/or events E1, E2, E3, E4 and E5 set by the programmer. Accordingly, the function column 25 can contain standard functions for the initialization or for the termination, Finit and Fend, and programmed functions which a programmer created as part of their programming work. Each event is assigned a function to be executed. The example shows that different events—E1 and E4—can call up the same function—F2. The function specification given for the event E5 is intended to indicate that it is a function F1 in another block “FB.abc”.

An event-function assignment list 23 as shown in FIG. 3 can be created when programming a functional block as part of the programming work and can be stored together with the programmed functions. During the execution, the programmed functions are loaded together with the programmed event-function assignment 23.

The functions 21 can then be programmed or have been programmed such that they call up a function present in the same functional block or generate a corresponding event that triggers the execution of said function. And the functions 21 can be programmed or have been programmed such that they generate, for a function present in another functional block, a corresponding event that triggers the execution of said function.

The event generation by a function can take place such that a character sequence that is syntactically correct according to the desired event is generated and output in the function. Said event generation can also take place such that, for example, character sequences that are syntactically correct according to the desired event are passively stored in the programmed event-function assignment 23 and are then activated by a function.

If an event occurs during the processing of a functional block, in particular of a function thereof, the event-function assignment 23 can thus be used to determine a function to be executed accordingly. Said function can then be brought to execution, either within the functional block or after an output event in another functional block.

The event function assignment 23 is stateless and not blocked in its use by any system parameters. In this way, the processing of specific events is prevented from being delayed due to processing durations or waiting times.

FIG. 2 indicates that a functional block 20 with an event-function assignment 23 can also have an execution control chart 22. The two mechanisms can be combined with one another if necessary.

FIG. 4 shows a further aspect of the invention that can be provided in combination with the above aspects. Once again, 20 indicates a functional block that contains functions 21a to 21f that can be called up individually and are programmed individually, as is known. 22 is a known execution control chart that causes the calling up of functions in accordance with events in a known manner. It is stateful as described in the prior art.

However, a second state control apparatus 12 is provided. It can in this respect be a software-implemented component whose programming is created inside the functional block 20 or outside of it. FIG. 4 indicates the latter. However, the second state control apparatus 12 can also be part of the programming of a functional block 20 or it can be delivered in addition to and with the programming.

The second state control apparatus 12 operates such that it switches the state of the execution control chart 22 early from a value “occupied” to a value “free”. This in particular takes place before the processing of a function recently called up from the execution control chart 22 is completed or even started. This can e.g. take place as soon as the function call is completed or immediately after the execution of the function last called up from the execution control chart 22 begins.

In this way, it is ensured the execution control chart 22 is not blocked for the further use, in particular for the calling up of further functions in accordance with further events, due to a function being processed.

The second state control apparatus 12 can be adapted to modify the conventional state definition of a known state control apparatus. It can also be adapted to remove other obstacles to use for the early reuse of an execution control chart 22. It can also be adapted to replace a conventional state control.

In this aspect of the invention, an operating method for an IEC 61499-part-compatible computing apparatus can be adapted as described above. The execution control chart can be stateful. A state control is then performed such that the state is switched from “occupied” to “free” while or before a function previously called up by the execution control chart is executed.

In general, the computing apparatus is adapted to bring a functional block to be executed or a function to be executed to execution in an execution environment that is configured according to an execution environment data set created by the execution engine. The assignment of a function to be executed or a functional block to be executed to an execution environment can be performed by the operating system or another component of the computing apparatus. It can take place in an event-controlled manner in accordance with interventions by the event management apparatus 14.

Protection apparatus can be provided to avoid access conflicts. There can be constellations in which it is undesirable that, during the execution of one function, another function is executed, or that one and the same function is executed twice, or that functions have read or write access to the same data. To avoid such access conflicts, settable protection apparatus can be provided such that they become part of the programming by a programmer. Semaphores or mutexes can be used here that are set and reset appropriately and that are observed. In this respect, the observation can in particular take place if a functional block or a function is assigned to an execution environment, or if the functional block or the function is to be executed when an assignment has already taken place. The observation of protection mechanisms can therefore, for example, take place at operating system level or at the level of the event management apparatus 14. However, it can also be a separately designed mechanism.

A first mutex or a first semaphore can protect against double execution of a function or a functional block. It can be set when the functional block to be protected or the function to be protected is executed for the first time and can be reset when the first execution is complete. During the set state, it is then not possible to execute the functional block marked in this way or the function marked in this way a second time.

A protection apparatus can also serve to block the execution of a function or a functional block in general. As described, the functional block to be blocked or the function to be blocked is then marked with a mutex or a semaphore at the start of the desired blocking. If the blocking is no longer required, the mutex or semaphore is reset.

In particular in priority-labeled functions and functional blocks, it can furthermore be desirable to protect an executed functional block or an executed function against interruption. In this respect, a protection mechanism can also be provided that is set at the start of the execution not to be interrupted and that is reset after this execution has ended. It can also be a suitably designed semaphore or mutex here. The setting and resetting of the protection apparatuses, or at least the specification as to when the setting and resetting is to take place, are part of the programming of a functional block and are then also part of the program and accordingly occupy areas corresponding to the program memory.

The memory area of the computing apparatus, in particular the program memory, can be written with data and/or instructions and/or information for executing or implementing one or more of the mentioned protection mechanisms and/or protection apparatuses.

The computing apparatus in general can be adapted for the multiple execution of programs and program parts, in particular functional blocks and functions thereof. The parallel execution can take place truly simultaneously or virtually simultaneously in a time multiplex. The truly simultaneous execution at least requires different arithmetic logic units that can then, however, use the same other resources such as memories, interfaces, registers or similar, where possible. With the virtually simultaneous execution, work can be carried out in a time multiplex and the computing power of hardware can be assigned in a distributed manner to a plurality of executions of a plurality of functions or functional blocks.

The features described in this description and the claims or shown in an illustration should be considered as mutually combinable even if their combination is not explicitly described, provided that the combination is technically possible. Features described in a specific context, in a specific embodiment, a Figure or a specific claim should also be viewed as separable from this claim, context, embodiment or Figure and combinable with any other Figure, claim, embodiment or context, provided that this is technically possible. Embodiments and Figures should not be understood as necessarily exclusive with respect to one another. Descriptions of a method or a sequence or a method step or a sequence step are also to be understood as descriptions of devices and/or possibly program instructions of an executable code on a data carrier that are suitable for implementing the method or the sequence or the method step or the sequence step, and/or are also to be understood as a description of an artifact that was generated or processed by the method or sequence or method step or sequence step, and vice versa. In the present description, the term invention is understood as the teaching subjectively developed by the inventor.

### REFERENCE NUMERAL LIST

10 computing apparatus
11 first state control apparatus
12 second state control apparatus
13 program, program memory
14 event management apparatus
17 protection apparatuses
18 execution engine
19 hardware, operating system
20 functional block
21 function
22 execution control chart
23 event-function assignment list
24 event column
25 function column
28 functional block-internal transition
28 transition to external functional block
50 execution environment data set list
51 data set column
71 input events
72 output events
73 input data
74 output data

1. An IEC 61499-part-compatible computing apparatus comprising
an arithmetic logic unit, a RAM, a ROM, an operating system memory, one or more interfaces for the input and/or output of data and signals and a bus connecting one or more or all of the above and/or the following components,
a program memory that is adapted to store a program that has one or more functional blocks, wherein a functional block has one or more programmed functions and can have a programmed execution control chart,
an execution engine that is adapted to create a first execution environment data set for configuring an execution environment for executing a functional block of a program,
characterized in that
the execution engine is adapted to create a second execution environment data set while or before a functional block or a function is executed in an execution environment that is configured by a first execution environment data set previously created by the execution engine.

2. The computing apparatus according to claim 1, in which the execution engine is adapted, together with the creation of a second execution environment data set, to also set up a second execution environment as usable or executable in accordance with the data of the second execution environment data set.

3. The computing apparatus according to claim 1,
in which the execution engine has an operationally dependent state and in which a first state control apparatus for directly or indirectly controlling the state of the execution engine comprises that said execution engine creates or can create a second execution environment data set after the creation of a first execution environment data set but before the use or before the termination of the use of said first execution environment data set.

4. The computing apparatus according to claim 1, comprising
a first state control apparatus for controlling the state of the execution engine, wherein the state comprises at least the two values “occupied” or “free” and is switched between at least these values by the first state control apparatus,
wherein the first state control apparatus is adapted to switch the state of the execution engine from “occupied” to “free” immediately after the execution engine has created a first execution environment data set or while a functional block is executed in an execution environment that is configured by a first execution environment data set previously created by the execution engine.

5. The computing apparatus according to claim 1, in which the execution engine is adapted to define one or more of the following parameters for an execution environment data set:
a priority specification relating to a functional block to be executed in the execution environment,
an arithmetic logic unit to be used for the execution of the functional block or an arithmetic logic unit type,
an identification of the execution environment data set.

6. The computing apparatus according to claim 1, in which the execution engine and/or the first state control apparatus are software-implemented and can be a part of the operating system or a component that is independent thereof.

7. The computing apparatus according to claim 1, in which the execution engine is adapted to create an execution environment data set if a functional block is to be executed, even if a further functional block is already being executed, and/or is adapted to create, without a current requirement, one or more execution environment data sets and to set them up such that they can be called up and, if necessary, selected by the operating system for the execution of a functional block, and/or is adapted to set up an execution environment data set such that it can be called up by the operating system and evaluated for the execution of a functional block.

8. An operating method for an IEC 61499-part-compatible computing apparatus that can be adapted according to claim 1, in which an execution engine creates a second execution environment data set while a functional block is executed in an execution environment that is configured by a first execution environment data set previously created by the execution engine.

9. An IEC 61499-part-compatible computing apparatus that can be adapted according to claim 1, comprising
an arithmetic logic unit, a RAM, a ROM, an operating system memory, one or more interfaces for the input and/or output of data and signals and a bus connecting one or more or all of the above and/or the following components,
a program memory that is adapted to store a program during the execution thereof, wherein the program has one or more functional blocks, wherein a functional block has one or more programmed, individually executable functions that can generate events,
wherein
a memory is adapted to store, with and for a functional block, an event-function assignment list, taken from the programming of the functional block, of one or more event-function assignments that each assign, to a specific event occurring in the computing apparatus, a function of a functional block, said function to be executed in
the computing apparatus in response to this event, and the computing apparatus is adapted, in response to a specific event, to bring a specific functional block and/or a specific function therein to execution in accordance with an entry in the event-function assignment,
the computing apparatus comprising an event control apparatus, and
wherein the event control apparatus can be software-implemented and can be part of the operating system and can be adapted to register an event generated by an executed function and, in dependence thereon and on further operating parameters, to bring a function of a functional block to execution.

10. The computing apparatus according to claim 9, in which the event named in an event-function assignment is an event occurring in the functional block that contains the event-function assignments or an event occurring in another functional block, and/or in which the function named in an event-function assignment is a function programmed in the functional block that contains the event-function assignments or a function programmed in another functional block.

11. The computing apparatus according to claim 9, in which the event of an event-function assignment has an event identification unique in the program and optionally also a priority specification for the event and optionally also an identification, unique in the program, of the functional block that contains the event-function assignment with the event, and/or in which the function of an event-function assignment has a function identification unique in the program and optionally also a priority specification for the function and optionally also an identification, unique in the program, of the functional block that contains the function.

12. The computing apparatus according to claim 9, in which the event control apparatus registers an event generated by an executed function and, in dependence thereon and on further operating parameters, brings a function of a functional block to execution.

13. The computing apparatus according to claim 9, in which the program memory is adapted to also store a programmed execution control chart for a functional block, wherein the computing apparatus is adapted to process the functional block or functions thereof in accordance with the execution control chart.

14. A program memory that has a program for a computing apparatus that is partly compatible with IEC 61499, wherein the program has one or more functional blocks, wherein a functional block has one or more programmed, individually executable functions that can generate events, wherein the program memory has at least one memory area that stores, for a functional block, a programmed event-function assignment of one or more event-function assignments that each assign, to a specific event generated in the stored program, a function of a functional block, said function to be executed in the computing apparatus in response to this event,
wherein the stored event of a stored event-function assignment can have an event identification unique in the program and optionally also a priority specification for the event and optionally also an identification, unique in the program, of the functional block that contains the event-function assignment with the event, and/or in which the stored function of a stored event-function assignment has a function identification unique in the program and optionally also a priority specification for the function and optionally also an identification, unique in the program, of the functional block that can have the function.

15. An operating method for an IEC 61499-part-compatible computing apparatus, wherein the method can be adapted according to claim 8, and in which an event-function assignment taken from the programming of a functional block is loaded and, in response to a specific event, a specific functional block and/or a specific function therein is/are executed in accordance with an entry in the event-function assignment.

16. An IEC 61499-part-compatible computing apparatus, comprising
an arithmetic logic unit, a RAM, a ROM, an operating system memory, one or more interfaces for the input and/or output of data and signals and a bus connecting one or more or all of the above and/or the following components,
a program memory that is adapted to store a program that has one or more functional blocks, wherein a functional block has one or more programmed functions and a programmed execution control chart,
a second state control apparatus for controlling the state of an execution control chart of an executed functional block of a program, wherein the state comprises at least the two values “occupied” or “free” and is switched between at least these values by the second state control apparatus,
wherein
the second state control apparatus is adapted to switch the state of an execution control chart from “occupied” to “free” while or before a function called up by the execution control chart is executed.

17. The computing apparatus according to claim 16, in which the second state control apparatus can be adapted to modify the state definition of a known state control apparatus, wherein the second state control apparatus can be software-implemented and can be part of the programming of a functional block.

18. An operating method for an IEC 61499-part-compatible computing apparatus, wherein the method can be adapted according to claim 8, and in which the state of an execution control chart can assume at least the two values “occupied” or “free” and the state of the execution control chart is switched from “occupied” to “free” while or before a function called up by the execution control chart is executed.

19. An operating method for an IEC 61499-part-compatible computing apparatus, wherein the method can be adapted according to claim 15, and in which the state of an execution control chart can assume at least the two values “occupied” or “free” and the state of the execution control chart is switched from “occupied” to “free” while or before a function called up by the execution control chart is executed.

20. A computing apparatus according to claim 1, in which the operating system is adapted to bring a functional block to be executed or a function to be executed to execution in an execution environment that is configured with an execution environment data set created by the execution engine.

21. A computing apparatus according to claim 1, comprising an event management apparatus that can be part of the operating system and/or that can be software-implemented and that is adapted
to record events generated by functions, wherein such events can comprise the specification of a function to be executed and/or a functional block to be executed and can comprise a priority specification for the function to be executed and/or the functional block to be executed, and/or
to assign the function specified in the recorded event or the specified functional block to the execution of an execution environment that is configured with an execution environment data set created by the execution engine, or to enter the specified function or the specified functional block in a queue if no execution environment is available, and/or
to collect event-function assignments from one or more event-function assignments of one or more functional blocks and to perform the assignment of a function or a functional block to an execution environment in accordance with the collected lists.

22. A computing apparatus according to claim 1, comprising a programmable protection apparatus for blocking the execution of a function or a functional block and/or for protecting a sequence, wherein the programmable protection apparatus can be adapted to take its programming from the programming of a functional block or a function and to operate accordingly and/or to operate in accordance with specifications from an executed function or an executed functional block, wherein the programmable protection apparatus can be implemented by the operating system, wherein the computing apparatus
can have a first protection apparatus for protecting a function or a functional block against double execution, wherein the protection apparatus can have a first mutex or a first semaphore that is set on a first execution of the function to be protected or of the functional block to be protected and that is reset on the termination of said function or functional block,
and/or can have a second protection apparatus for blocking the execution of a function or a functional block, wherein the second protection apparatus can have a second mutex or a second semaphore that is set on an execution of another function or another functional block and that is reset on the termination of said function or functional block,
and/or can have a third protection apparatus for protecting a function call against interruption, wherein the third protection apparatus can have a third mutex or a third semaphore that is set on an execution of another function or another functional block and that is reset on the termination of said function or functional block.

23. An operating method according to method claim 8, in which one or more protection methods are used.
